(19) United States
(12) Patent Application Publication
(10) Pub. No.: US 2026/0217456 A1
(43) Pub. Date: Jul. 30, 2026

(54) A STORAGE SYSTEM FOR STORAGE CONTAINERS COMPRISING A FRAMEWORK STRUCTURE, STACKER FRAMES, STORAGE CONTAINERS, A STACKER FRAME LIFTER AND A CONTAINER LIFTER

(71) Applicant: AutoStore Technology AS, Nedre Vats (NO)

(72) Inventor: Jørgen Djuve Heggebø, Langhus (NO)

(21) Appl. No.: 19/142,704

(22) PCT Filed: Dec. 20, 2023
(86) PCT No.: PCT/EP2023/086851

§ 371 Date: Jun. 24, 2025

(30) Foreign Application Priority Data
Dec. 27, 2022 (NO) 20221408

(51) Int. Cl. B65G 1/04

(52) U.S. Cl. CPC B65G 1/0464; B65G 1/0407

(57) ABSTRACT

The present invention provides a storage system (1) for storage containers, the storage system comprising a framework structure (100), stacker frames (6), storage containers (106), a stacker frame lifter (8) and a container lifter (201, 301, 401); the framework structure defines a plurality of storage columns (105), and each storage column accommodates a plurality of the stacker frames (6) arranged one on top of another in a vertical stack; each of the stacker frames (6) has an open top end and is configured to accommodate a plurality of the storage containers (106) stored one on top of another in a vertical stack; the stacker frame lifter (8) and the container lifter (201, 301, 401) are configured to move in two perpendicular directions above the storage columns; the container lifter is configured to retrieve a storage container (106) via the open top end (9) of an upper stacker frame (6′) of a stack of stacker frames; and the stacker frame lifter (8) is configured to retrieve an upper stacker frame (6′) accommodated in a storage column.

### BACKGROUND AND PRIOR ART

FIG. 1 discloses a prior art automated storage and retrieval system 1 (i.e. a storage system), with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminium profiles.

The framework structure 100 of the automated storage and retrieval system 1 comprises a rail system 108 (i.e. a rail grid) arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301,401 comprises a vehicle body 201a,301a,401a and a wheel assembly featuring first and second sets of wheels 201b,201c,301b,301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b,301b,201c,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 2 comprising container connectors 3, adapted to engage connecting recesses 13 at an upper rim of the sidewalls 14 of a storage container 106, see FIG. 5, and guiding pins 4. The guiding pins 4 are arranged to interact with guiding pin recesses 7 at the corners of the storage container and ensure a correct alignment of the lifting frame 2 and container connectors 3 relative to the storage container. The guiding pins 4 will also assist in guiding the lifting frame 2 relative to the upright members of the storage column 105. The lifting frame 2 can be lowered from the vehicle 201,301,401 so that the position of the lifting frame 2 with respect to the vehicle 201,301,401 can be adjusted in a third direction Z which is orthogonal the first direction X and the second direction Y. The lifting device of the container handling vehicle 201 is located within the vehicle body 201a in FIG. 2.

To raise or lower the lifting frame 2 (and optionally a connected storage container 106), the lifting frame 2 is suspended from a band drive assembly by lifting bands 5. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer for storing storage containers below the rail system 108, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090984A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304A1, the contents of which are incorporated herein by reference, illustrates a typical configuration of rail system 108 comprising rails and parallel tracks in both X and Y directions forming a rail grid.

In the framework structure 100, most of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the storage columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the storage system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the storage 1 comprises a control system 500 which typically is computerized and which typically comprises a database for keeping track of the storage containers 106.

The prior art storage systems are restricted regarding the height of the stacks of storage containers by the practical lifting height of the container handling vehicles and/or the weight that may be supported by the lower storage container in a stack of storage containers. Further, a storage system in which the storage container may be rearranged more efficiently would be advantageous.

### SUMMARY OF THE INVENTION

The present invention is defined by the attached claims and in the following:
In a first aspect, the present invention provides a storage system for storage containers, the storage system comprising a framework structure, stacker frames, storage containers, a stacker frame lifter and a container lifter;
the framework structure defines a plurality of storage columns, and each storage column accommodates a plurality of the stacker frames arranged one on top of another in a vertical stack;
each of the stacker frames has an open top end and is configured to accommodate a plurality of the storage containers stored one on top of another in a vertical stack;
the stacker frame lifter and the container lifter are configured to move in two perpendicular directions above the storage columns;
the container lifter is configured to retrieve a storage container via the open top end of an upper stacker frame of a stack of stacker frames; and
the stacker frame lifter is configured to retrieve an upper stacker frame accommodated in a storage column.

The stacker frame lifter and the container lifter may be configured to move/transport a stacker frame or storage container, respectively, in two perpendicular directions above the storage columns. The stacker frame lifter and the container lifter may be configured to releasably connect a stacker frame or storage container, respectively, and lift/lower the respective stacker frame or storage container from/into a storage column.

The open top end of the stacker frame may be for vertical passage of a storage container.

The stacker frame is configured to support the bottom of a lowermost storage container of a stack of storage containers accommodated in the stacker frame.

A stacker frame may comprise a bottom section, for supporting the lower end of a stack of storage containers, a top section having an open end through which a container may pass in a vertical direction, side sections extending between the bottom section and the top section, the side sections configured to guide the vertical movement of a lifting frame inside the stacker frame, and connecting recesses arranged at an upper portion of the side sections or at an upper rim of the top section, the connecting recesses being suitable for releasable connection to a stacker frame lifter.

The stacker frame may have an outer periphery, fitting within an inner periphery of a storage column, and an inner periphery within which an outer periphery of a storage container will fit.

In an embodiment of the storage system, the stacker frame lifter may be configured to move in the two perpendicular directions on or above the rail system.

In an embodiment of the storage system, the container lifter may comprise a first type of lifting frame configured to releasably connect to an upper portion of a storage container. The first type of lifting frame may have an outer periphery being smaller than an inner periphery of the stacker frame. The inner periphery of the stacker frame may be configured to guide the vertical movement of the first type of lifting frame within the stacker frame, i.e. the inner periphery of the stacker frame may comprise vertical surfaces configured to guide vertical movement of the lifting frame. The vertical surfaces may comprise portions of side sections of the stacker frame, the portions forming vertical corner sections for accommodating corresponding corners of the lifting frame.

In an embodiment of the storage system, the first type of lifting frame may comprise grippers configured to releasably connect to connector recesses arranged in an upper rim of the storage container.

In an embodiment of the storage system, the first type of lifting frame may comprise extendable guiding elements, the guiding elements are biased towards an extended position, in which they may interact with vertical column profiles of a storage column, and may be forced into a retracted position in which the first type of lifting frame may be guided by interaction with internal surfaces of the stacker frame.

In an embodiment of the storage system, the container lifter may comprise the first type of lifting frame and a guide frame, the guide frame being arranged above the first type of lifting frame and having an outer periphery being larger than the inner periphery of the stacker frames and smaller than an inner periphery of the storage columns. The outer periphery of the guide frame may be larger than an outer periphery of the first type of lifting frame. The outer periphery of the guide frame may be equal to an outer periphery of the stacker frames. The guide frame may comprise apertures through which the lifting bands from the first type of lifting frame pass. The guide frame may be configured to be supported by the lifting frame when the lifting frame is removed from, i.e. not within, a stacker frame. The guide frame may be configured as a framework or plate element.

In an embodiment of the storage system, the stacker frame lifter may comprise a second type of lifting frame configured to releasably connect to an upper portion of a stacker frame. The second type of lifting frame may have a periphery being smaller than an inner periphery of a storage column. The second type of lifting frame may be configured to reach lower into the storage column than the first type of lifting frame.

In an embodiment of the storage system, each stacker frame may have two opposite side sections, each side section comprises a recess arranged at an inner surface thereof, and the second type of lifting frame comprises latches, each latch configured to enter a corresponding recess from inside the stacker frame when the stacker frame is releasably connected to the second type of lifting frame.

The recess may be an aperture extending from the inner surface to an outer surface of the side section, i.e. the recess may be an aperture or opening in the side section. In other words, the recess may be arranged in an upper portion of the inner surface of a side section.

In an embodiment of the storage system, the second type of lifting frame may comprise a horizontal base frame and at least one latch arranged at each of two opposite sides of the base frame, a connecting portion of each latch being configured to move between a release position and a connecting position, in the release position the connecting portion is closer to a vertical centreline of the base frame than in the connecting position. In the connecting position, the latch may extend through a corresponding recess in the side section of a stacker frame.

In an embodiment, the storage system may comprise a rail system on which the container lifter may move in the two perpendicular directions, the rail system being arranged above the storage columns.

The framework structure may comprise a plurality of vertical column profiles defining the storage columns. The rail system may be arranged on top of, and supported by, the vertical column profiles. The rail system may comprise a first set of parallel rails arranged to guide movement of the container lifter and/or the stacker frame lifter in a first direction across the top of the framework structure, and a second set of parallel rails arranged perpendicular to the first set of rails to guide movement of the container lifter and/or the stacker frame lifter in a second direction being perpendicular to the first direction.

In an embodiment of the storage system, the container lifter and/or the stacker frame lifter may comprise a wheel assembly featuring first and second sets of wheels which enable movement of the container lifter and/or the stacker frame lifter in in the two perpendicular directions on the rail system. The first set of wheels may be arranged to engage with a first set of parallel rails of the rail system, and the second set of wheels may be arranged to engage with a second set of parallel rails of the rail system. At least one of the sets of wheels can be lifted and lowered relative to the other set of wheels, so that the first set of wheels and/or the second set of wheels can be engaged with the respective set of rails at any one time.

In an embodiment of the storage system, at least one of the stacker frames does not accommodate storage containers, such that the at least one stacker frame may be used to accommodate items being too large for storage in the storage containers, i.e. items being too large to be accommodated in the storage containers. In other words, the storage system may comprise a first set of stacker frames accommodating stacks of storage containers and a second set of stacker frames accommodating items being too large for storage in the storage containers.

In a second aspect, the present invention provides a stacker frame and storage container assembly for a storage system according to any embodiment of the first aspect, comprising a stacker frame accommodating a plurality of storage containers stacked on top of another forming a stack.

In an embodiment of the stacker frame and storage container assembly, the stacker frame may comprise a bottom section, for supporting a lower end of the stack of storage containers, a top section having an open end through which a storage container may pass in a vertical direction, side sections extending between the bottom section and the top section, and connecting recesses arranged at an upper portion of the side sections or at an upper rim of the top section. The connecting recesses of the stacker frame may be arranged at a level above the stack of storage containers.

In an embodiment of the stacker frame and storage container assembly, the connecting recesses of the stacker frame extend from an inner surface of the stacker frame. The connecting recesses of the stacker frame may be apertures extending from an inner surface to an outer surface of a side section of the stacker frame.

In an embodiment of the stacker frame and storage container assembly, each of the storage containers may comprise connecting recesses in/at an upper rim thereof.

In an embodiment of the stacker frame and storage container assembly, the bottom section of the stacker frame may comprise a recessed or stepped portion having an outer periphery being smaller than an inner periphery of the top section, such that two stacker frames may be stacked on top of another and horizontal movement between the two stacker frames restricted.

In a third aspect, the present invention provides a method of retrieving a target storage container from a storage system according to any embodiment of the first aspect, comprising the steps of:
identifying a storage column accommodating a target stacker frame in which the target storage container is stored;
moving the stacker frame lifter to a position above the storage column;
retrieving at least one stacker frame, stacked above the target stacker frame, from the storage column, and optionally storing said stacker frame in another storage column, until the target stacker frame is the upper stacker frame in the storage column;
optionally retrieving the target stacker frame from the storage column and moving the target stacker frame to another storage column in which the target stacker frame is stacked at an upper level of the storage column (when stacked at an upper level of the storage column, the open end of the target stacker frame is at a level directly below a rail system arranged above the storage column); and
retrieving the target storage container from the target stacker frame by use of the container lifter.

In a fourth aspect, the present invention provides a lifting device for a container lifter in a storage system according to the first aspect, the lifting device comprises a first type of lifting frame and a guide frame, the guide frame being arranged above the first type of lifting frame and having an outer periphery being larger than the outer periphery of the first type of lifting frame, the guide frame may comprise apertures through which the lifting bands from the first type of lifting frame pass. The guide frame may be configured as a framework or plate element.

In a fifth aspect, the present invention provides a storage system for storage containers, the storage system comprising stacker frames, storage containers, a stacker frame lifter and a container lifter;
the stacker frames are arranged one on top of another in a plurality of adjacent vertical stacks;
each of the stacker frames has an open top end and is configured to accommodate a plurality of the storage containers stored one on top of another in a vertical stack;
the stacker frame lifter and the container lifter are configured to move in two perpendicular directions above the stacks of stacker frames;
the container lifter is configured to retrieve a storage container via the open top end of an upper stacker frame of a stack of stacker frames; and
the stacker frame lifter is configured to retrieve an upper stacker frame of a stack of stacker frames.

In an embodiment of the storage system according to the fifth aspect, the stacker frame lifter and the container lifter may be arranged to move above the stacks of stacker frames by a corresponding crane assembly. Each crane assembly may comprise a first gantry beam slidably connected to a second gantry beam, such that the first gantry beam may move in a first direction above the stacks of stacker frames. The respective stacker frame lifter or container lifter is slidably connected to the first gantry beam, such that the stacker frame lifter or container lifter may move in a second direction perpendicular to the first direction.

In an embodiment of the storage system according to the fifth aspect, a bottom section of each stacker frame may comprise a recessed or stepped portion having an outer periphery being smaller than an inner periphery of a top section of each stacker frame, such that two stacker frames may be stacked on top of another and horizontal movement between the two stacker frames restricted.

The storage system according to the fifth aspect may comprise features of any embodiment of the storage system according to the first aspect not being dependent on the framework structure.

### BRIEF DESCRIPTION OF THE DRAWINGS

Embodiments of the invention is described in detail by reference to the following drawings:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilevered section for carrying storage containers underneath.

FIG. 4 is a perspective view of a prior art container handling vehicle, wherein a container lifting assembly is shown.

FIG. 5 is a perspective view of a storage container as used in the storage system in FIG. 1.

FIGS. 6 to 11 show a first exemplary storage system according to the invention.

FIGS. 12 and 13 show a first exemplary combination of a stacker frame and storage containers for a storage system according to the invention.

FIG. 14 is a topside view of a storage column accommodating a stacker frame and storage container as shown in FIGS. 12 and 13.

FIGS. 15 and 16 are side views of a stacker frame lifter and a corresponding stacker frame.

FIG. 17 shows perspective views of the stacker frame lifter and the corresponding stacker frame in FIGS. 15 and 16.

FIGS. 18 and 19 show an exemplary embodiment of a lifting device for a container lifter.

FIG. 20 is a perspective view of a second exemplary storage system according to the invention.

FIG. 21 shows a second exemplary combination of a stacker frame and storage containers for a storage system according to the invention.

FIG. 22 shows a third exemplary combination of a stacker frame and storage containers for a storage system according to the invention.

FIG. 23 shows a stacker frame in which storage containers of different heights are stacked.

FIGS. 24 and 25 show an exemplary embodiment of a lifting device for a container lifter.

### DETAILED DESCRIPTION OF THE INVENTION

In the following, embodiments of the invention will be discussed in more detail with reference to the appended drawings. The drawings are not intended to limit the invention to the illustrated subject-matter.

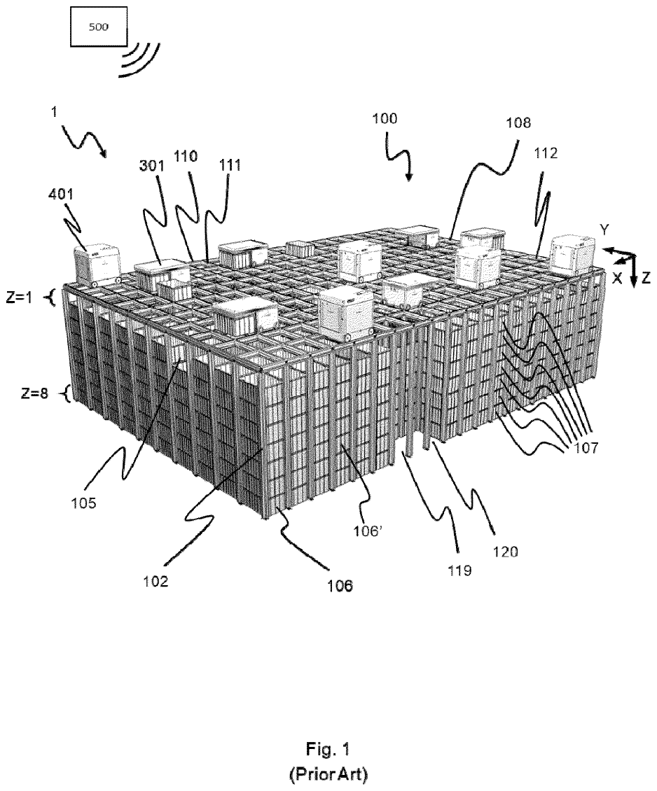

As discussed above, the prior art storage systems as shown in FIG. 1 are restricted regarding the height of the stacks of storage containers by the practical lifting height of the container handling vehicles and/or the weight that may be supported by the lower storage container in a stack of storage containers. It would further be advantageous to provide a storage system in which storage containers stored at the lower levels of the storage columns could be retrieved by a more efficient “digging”-operation.

The inventive storage system is configured to overcome some of the restrictions of the prior art systems and/or provide a storage system in which a “digging”-operation may be performed in a more efficient manner.

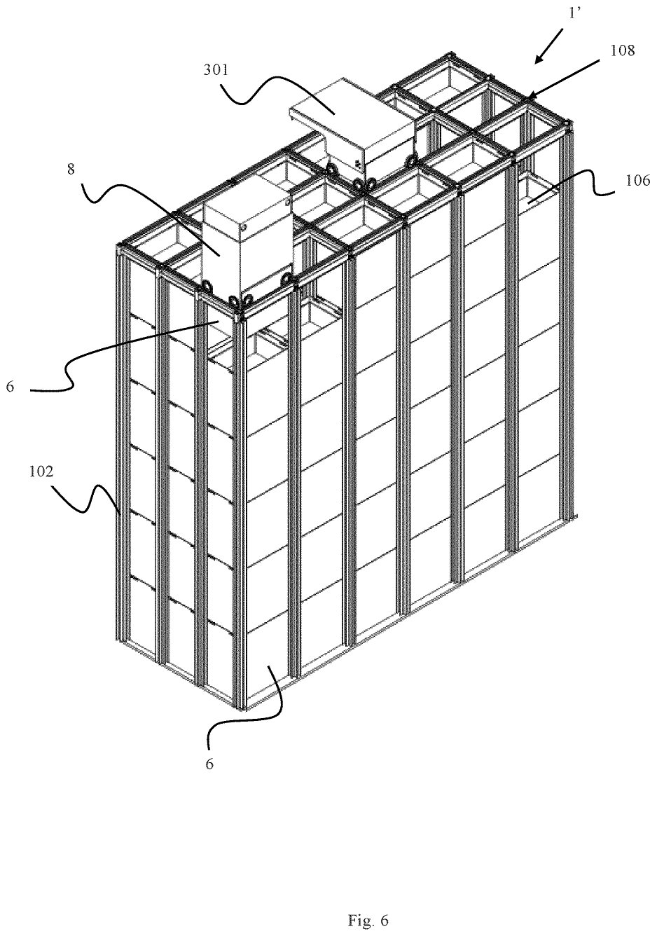

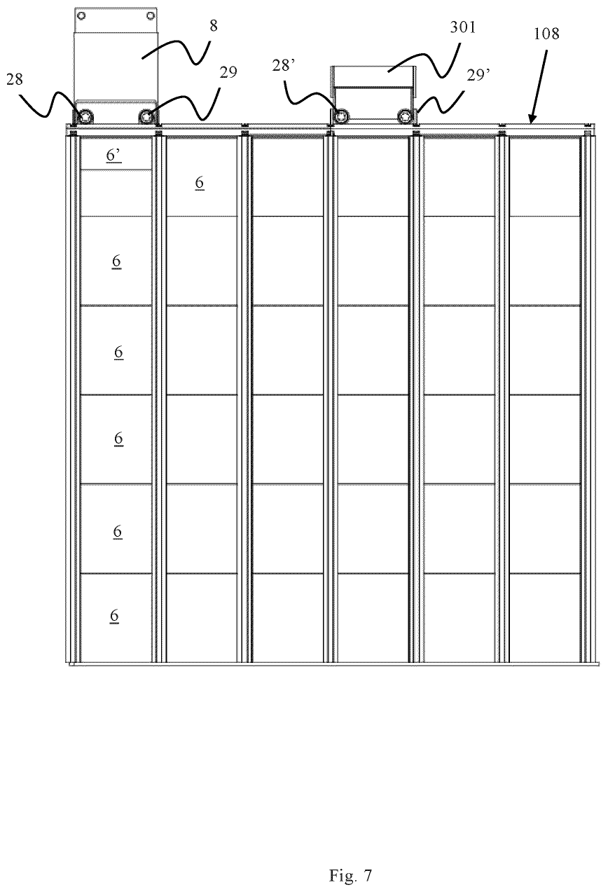

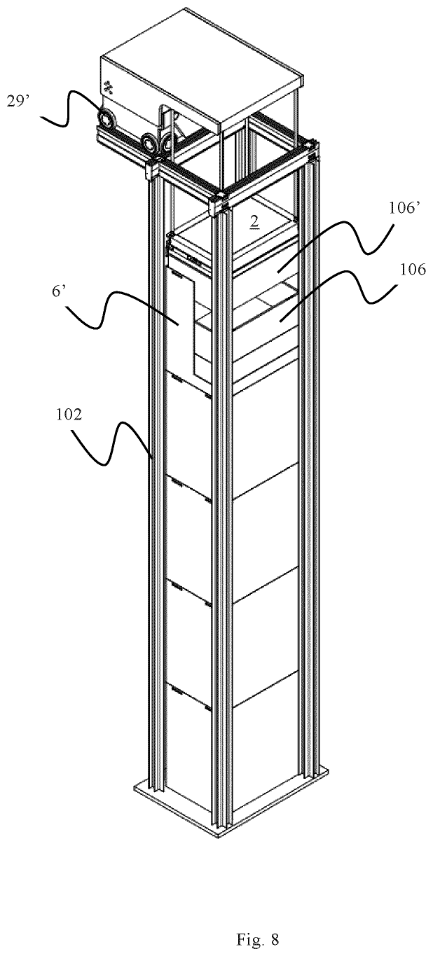

A first exemplary storage system is shown in FIGS. 6-11. The storage system 1′ comprises a framework structure 100, stacker frames 6, storage containers 106, a stacker frame lifter 8 and a container lifter 301. The framework structure 100, the storage containers 106 and the container lifter 301 may be similar to the corresponding features of the prior art system in FIG. 1.

The framework structure 100 features vertical column profiles 102 which define a plurality of storage columns 105. Each storage column 105 accommodates a plurality of the stacker frames 6 arranged one on top of another in a vertical stack. Each of the stacker frames 6 has an open top end 9 for vertical passage of a storage container 106 and is configured to accommodate a plurality of the storage containers 106 stored one on top of another in a vertical stack. The stacker frame 6 is configured to support the bottom of a lowermost storage container 106 in a stack of storage containers 106 accommodated in the stacker frame 6.

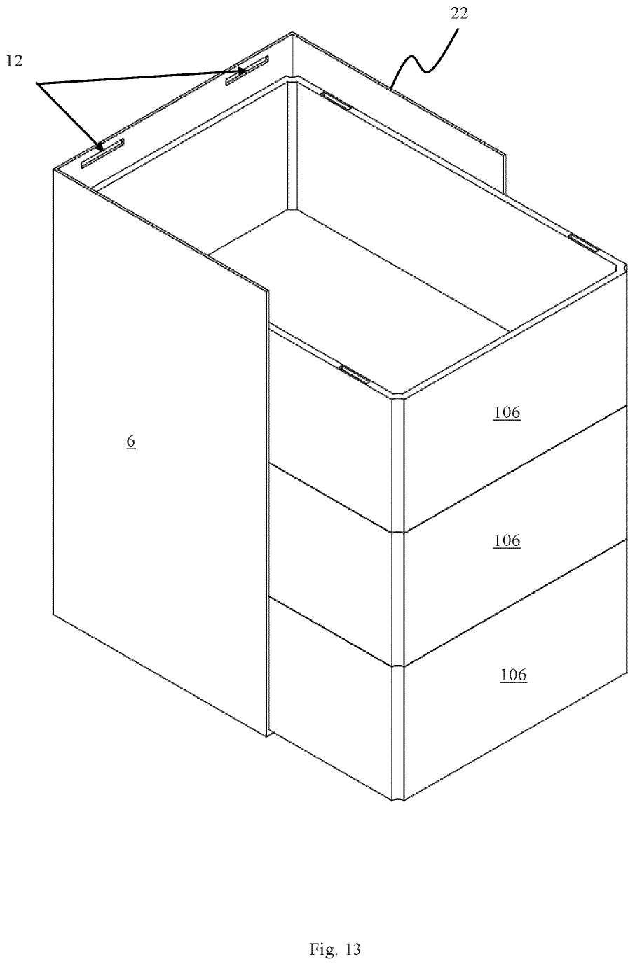

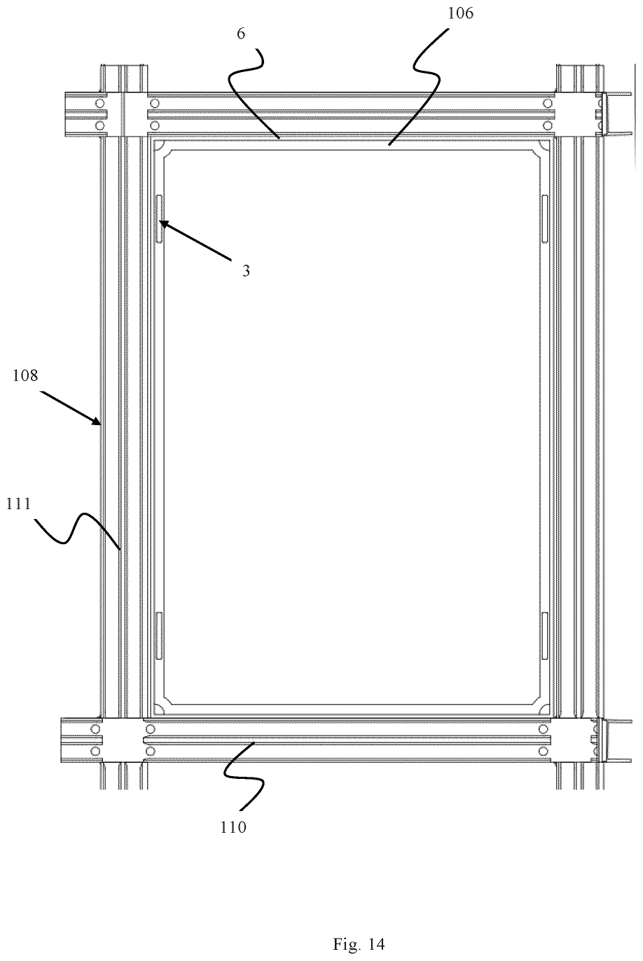

The stacker frame, see FIGS. 12 and 13, comprises a bottom section 18, for supporting a lower end of a stack of storage containers 106, a top section 19 featuring the open end 9, through which end a storage container 106 may pass in a vertical direction, side sections 20 extending between the bottom section 18 and the top section 19, and connecting recesses 12 arranged at an upper portion of opposite side sections 20. The connecting recesses 12 are arranged at a level above an upper level of a stack of storage containers 106 arranged in the stacker frame.

To improve the stability of a stack of stacker frames, the bottom section 18 of the stacker frame may have a recessed portion 23 having an outer periphery being smaller than, i.e. fitting within, an inner periphery of the top section 19. In this manner, the stacker frames 6 may be stacked on top of another while horizontal movement between them is restricted.

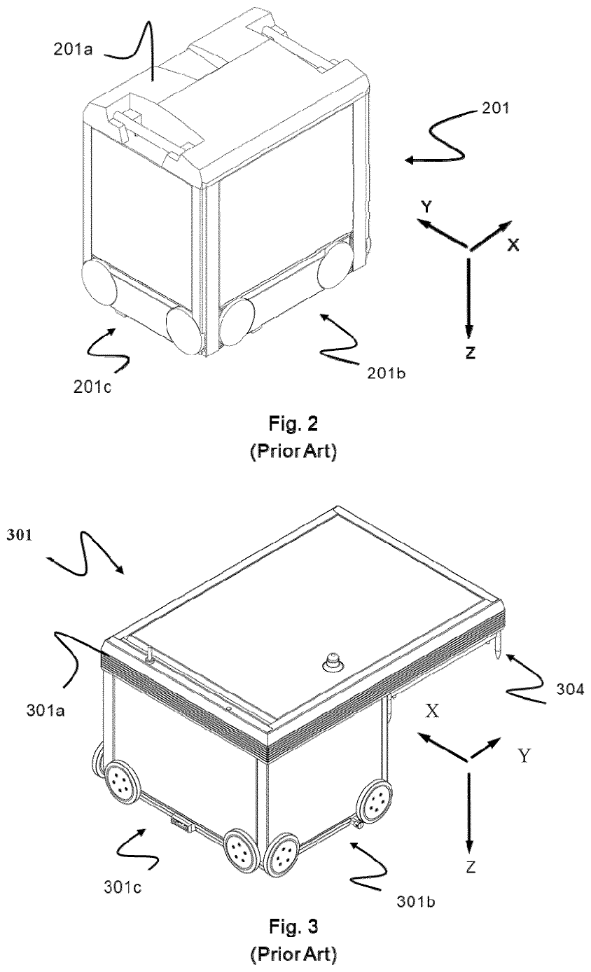

The storage system 1′ features a rail system 108 arranged above the storage columns 105. The stacker frame lifter 8 and the container lifter 301 are configured to move in two perpendicular directions on the rail system 108. Both the stacker frame lifter 8 and the container lifter 301 comprise a first set of wheels 28,28′ and second set of wheels 29,29′ for moving on the rail system 108. The sets of wheels may be as described for the prior art container handling vehicles in FIGS. 2-4.

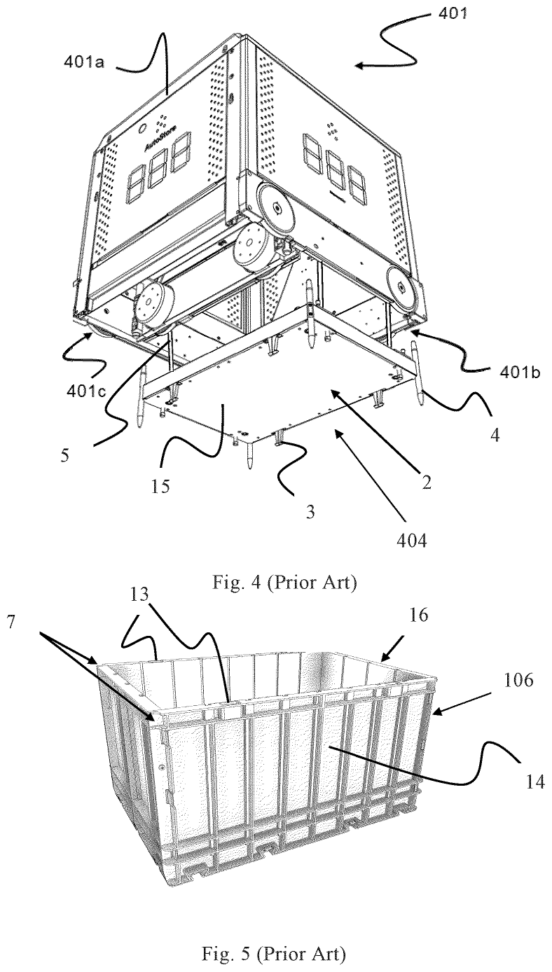

The container lifter 301 may be similar to the prior art container handling vehicle 301 in FIG. 3. The container lifter 301 features a first type of lifting frame 2 having grippers 3 configured to releasably connect to connector recesses 13 arranged in an upper rim 16 of a storage container 106, see FIG. 5. The first type of lifting frame 2 may be similar to the prior art lifting frame shown in FIG. 4. The container lifter 301 is configured to retrieve a storage container 106 via the open top end 9 of an upper stacker frame 6′ of a stack of stacker frames 6, see FIGS. 8 and 12. The upper stacker frame 6′ in FIG. 8 has a cut-away section to better illustrate the stacking of the storage containers 106 inside the stacker frame 6′. To retrieve a storage container 106 from a stacker frame 6, the first type of lifting frame 2 has an outer periphery being smaller than an inner periphery of the stacker frame 6. The inner periphery of the stacker frame 6 may be configured to guide the vertical movement of the first type of lifting frame 2 within the stacker frame 6.

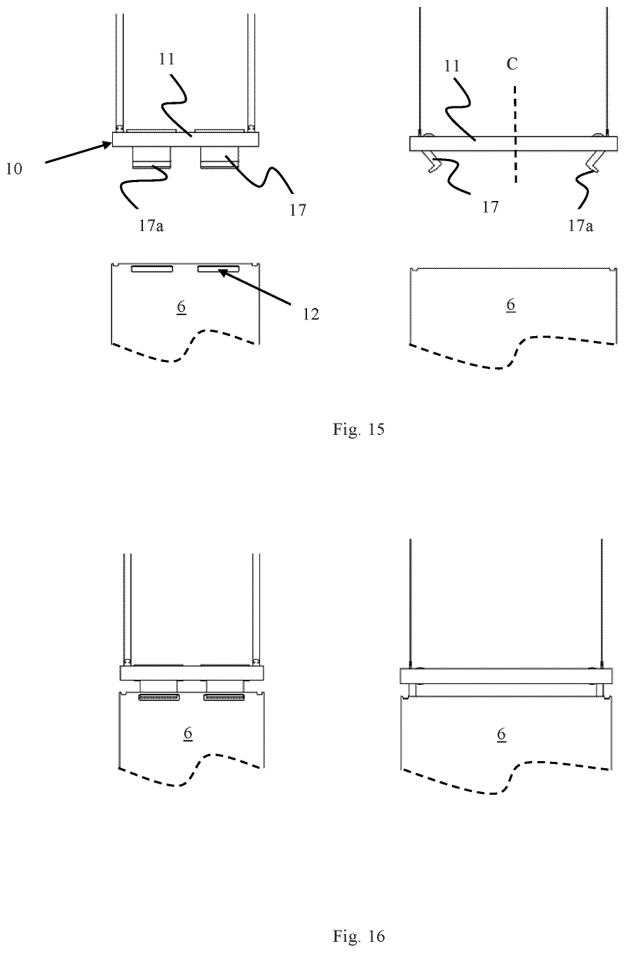

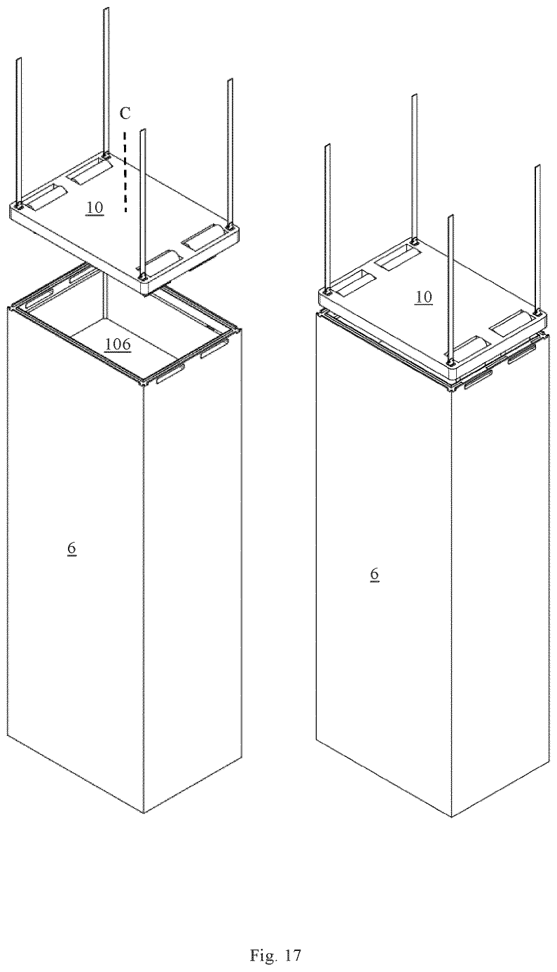

The stacker frame lifter 8 features a second type of lifting frame 10, see FIGS. 15 and 16. The stacker frame lifter 8 is configured to retrieve an upper stacker frame 6′ accommodated in a storage column 105. The second type of lifting frame 10 comprises a horizontal base frame 11 and latches 17 arranged at each of two opposite sides of the base frame 10. A connecting portion 17a of each latch 17 is configured to move between a release position, FIG. 15, and a connecting position, FIG. 16. In the release position the connecting portion 17a is closer to a vertical centreline C of the base frame 10 than in the connecting position. When moving from the release position to the connecting position, the connecting portion 17a is moved away from the vertical centreline C and may extend through a corresponding recess 12 in the side section 20 of a stacker frame 6. Having the latches 17 connecting to the stacker frame at an inner surface of the stacker frame is advantageous in that the space between adjacent stacks of stacker frames may be minimized. Further, the width of the side sections 20, or walls, of the stacker frames may be also be minimized provided the stacker frames are made in a material and/or have a configuration providing sufficient support for the stacker frames stacked above. The stacker frame lifter 8 may be similar to the prior art vehicles in FIGS. 2 and 4, wherein the size of the cavity is adapted to lift and move a stacker frame 6. To provide an increased lifting height, the second type of lifting frame 10 may be further modified, for example by having a guide shuttle as described in WO 2020/200631 A1.

The inventive storage system provides several advantages regarding the possibility of increasing the height of the storage columns. The stacker frames may be configured to support a stack of stacker frames being higher than a maximum height of a stack of storage containers. A stack of stacker frames is more stable than a stack of storage containers having a similar height since a specific stack height requires fewer individual stacked units compared to a stack of storage containers.

The stability of a stack of stacker frames is further improved by having a recessed portions 23 at the bottom section 18 of each stacker frame. In addition to the advantages related to improved height and stability, the inventive storage system is also advantageous in that storage containers arranged at lower levels of a storage column may be retrieved more efficiently.

Due to the stacker frames, relatively few storage containers are stacked on top of another. The low stacking height of the storage containers provides a further advantage of the inventive storage system in that it allows for the use of storage containers made in relatively weak materials, such as cardboard, in a cube storage system.

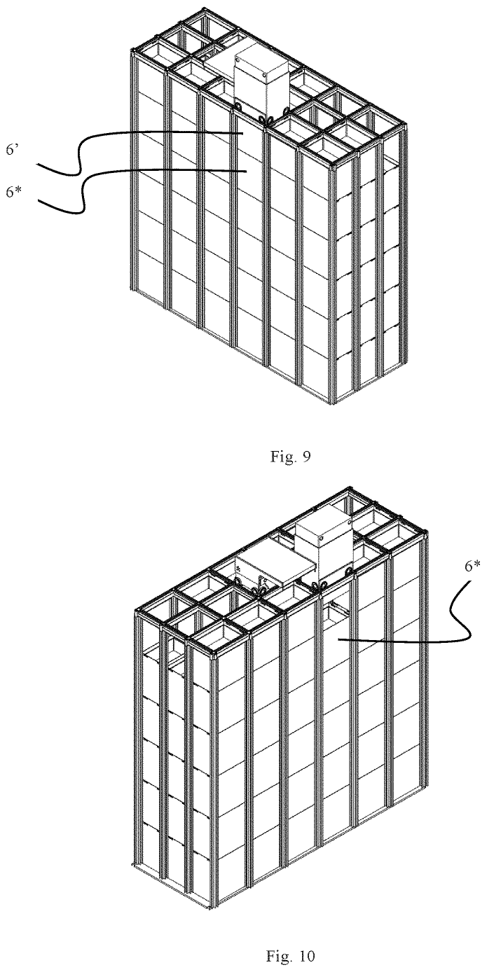

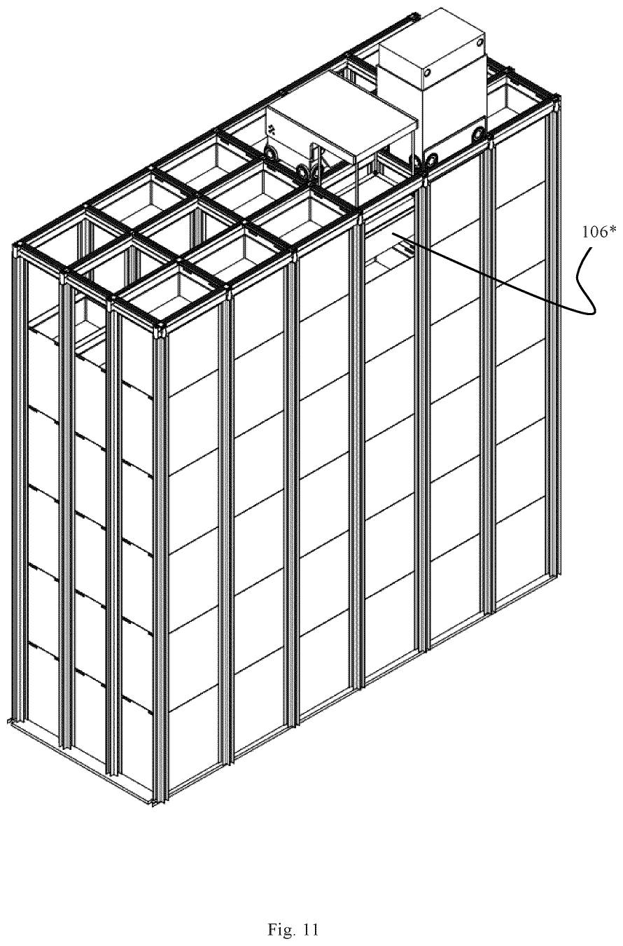

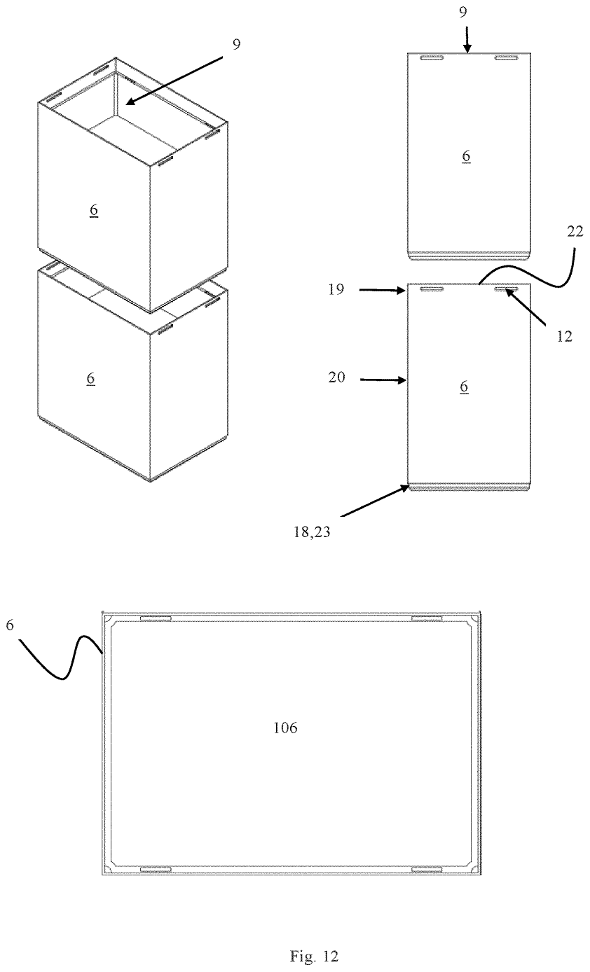

An advantageous method of retrieving a target storage container 6* from the above storage system is illustrated in FIGS. 9-11. The method comprises the steps of:
identifying a storage column 105 accommodating a target stacker frame 6* in which the target storage container 106* is stored;
moving the stacker frame lifter 8 to a position above the storage column 105 (FIG. 9);
retrieving at least one stacker frame 6′ (FIG. 10), stacked above the target stacker frame 6*, from the storage column 105 (the at least one stacker frame 6′ may optionally be stored in another storage column) until the target stacker frame 6* is the upper stacker frame in the storage column 105;
retrieving the target storage container 106* from the target stacker frame 6* by use of the container lifter 301 (FIG. 11).

Depending on the configuration of the container lifter 301 and/or the first type of lifting frame 2, the first type of lifting frame 2 may require guidance during vertical movement inside the storage column 105. If guidance is required, the method may comprise the following step before the target storage container 106* is retrieved by the container lifter 301.
retrieving the target stacker frame 6* from the storage column 105 and moving the target stacker frame 6* to another storage column 105 in which the target stacker frame 6* is stacked at an upper level of the storage column. When stacked at an upper level of the storage column 105, the open end 9 of the target stacker frame 6* is at a level directly below the rail system 108. In this manner, the first type of lifting frame 2 may be guided by internal surfaces of the target stacker frame 6* when moving into the storage column 105.

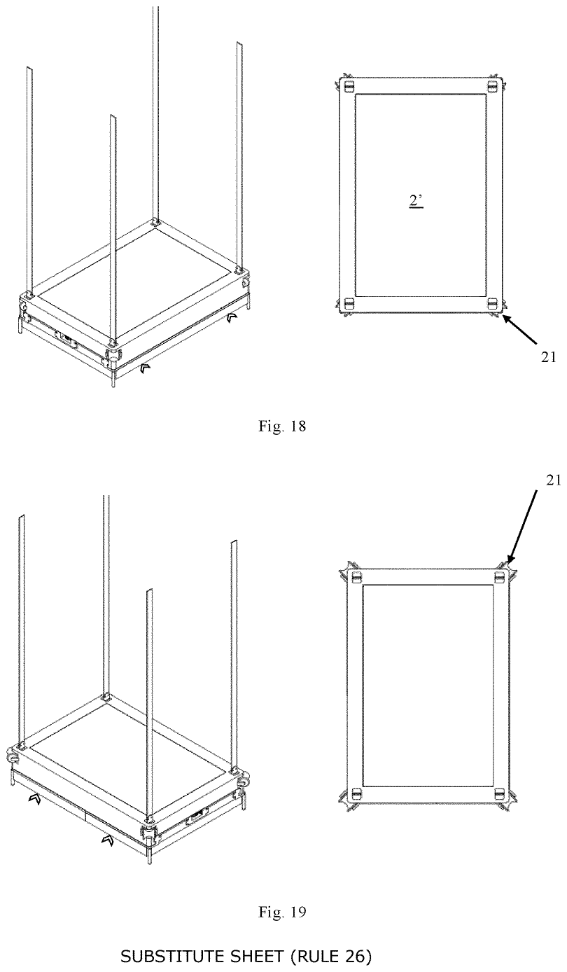

To provide guidance of the first type of lifting frame, independent of the stacker frames 6, when moving inside a storage column 105, the lifting frame 2′ may optionally comprise extendable guiding elements 21, see FIGS. 18 and 19. The guiding elements 21 are biased towards an extended position, see FIG. 19, in which they may interact with vertical column profiles 102 of a storage column 105 to provide guidance of the lifting frame 2′. When entering the open end 9 of a stacker frame 6 the guiding elements 21 are forced into a retracted position and further vertical movement of the lifting frame 2′ is guided by interaction with internal surfaces of the stacker frame. The guiding element 21 may e.g. comprise an arm configured to move a wheel between the extended and the retracted position.

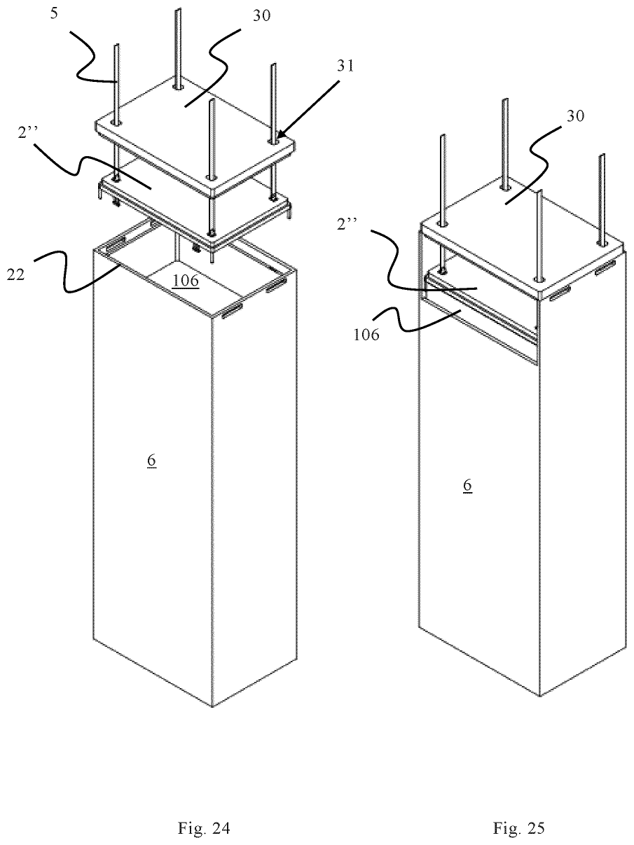

Guidance of the first type of lifting frame, independent of the stacker frames 6, when moving inside a storage column 105, may also be obtained by arranging a guide plate 30 above the lifting frame 2, see FIGS. 24 and 25. The guide plate 30 have an outer periphery being larger than the open end 9 of the stacker frames and smaller than an inner periphery of the storage columns. The outer periphery of the guide plate 30 may be substantially equal to an outer periphery of the stacker frames. The guide plate 30 features apertures 31 through which the lifting bands 5 from the lifting frame 2 pass. During use, corner sections of the guide plate 30 may interact with the vertical column profiles 102 of a storage column 105 to provide guidance of the lifting frame 2 during vertical movement. When the lifting frame 2 is lowered into a stacker frame 6, the guide plate 30 is supported by the upper rim 22 of the stacker frame 6 while the lifting frame 2 is allowed to enter the stacker frame 6 to retrieve or deliver a storage container 106. The guide plate 30 may be any type of suitable framework as long as its outer periphery provides the required guidance/interaction with the storage column.

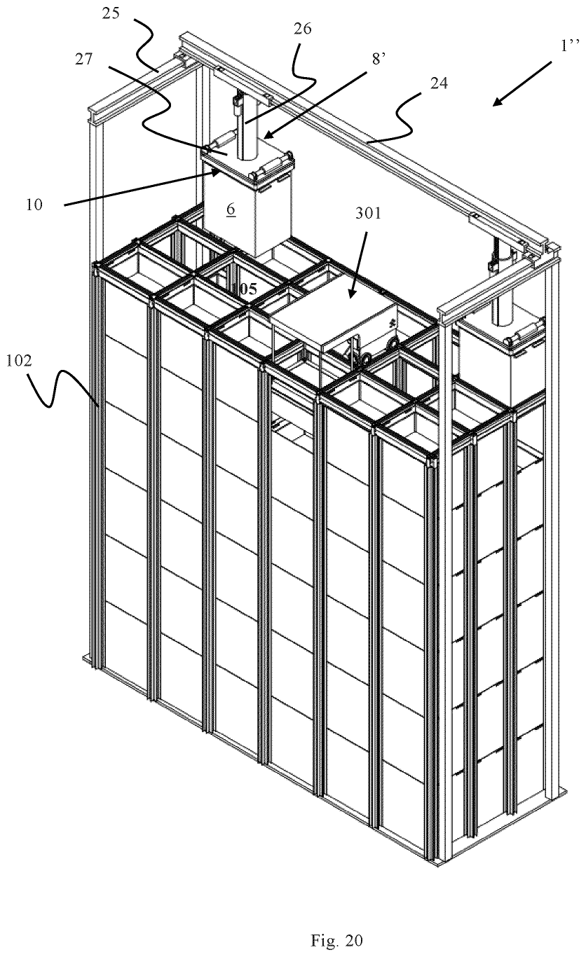

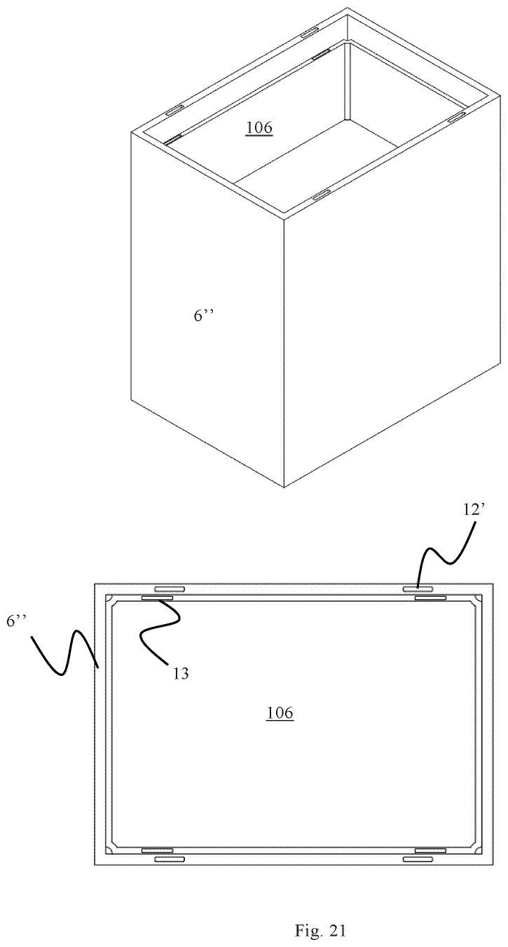

A second exemplary storage system 1″ is shown in FIG. 20. In the second exemplary storage system 1″, the stacker frame lifter 8′ is arranged to move above the storage columns 105 by a crane assembly. The crane assembly comprises a first gantry beam 24 slidably connected to a second gantry beam 25, such that the first gantry beam 24 may move in a first direction above the storage columns 105. The stacker frame lifter 8′ is slidably connected to the first gantry beam 24, such that the stacker frame lifter 8′ may move in a second direction perpendicular to the first direction. The second type of lifting frame 10 is suspended from a lifting platform 27 by lifting bands. The lifting platform may be connected to the first gantry beam 24 by a telescopic arm 26. The telescopic arm 26 is configured to move the lifting platform between an upper position in which the stacker frame lifter 8′ may move a stacker frame above the storage columns 105, and a lower position in which the lifting frame, and any connected stacker frame, may be lowered into a storage column. In the upper position, the bottom section 18 of a stacker frame 6 connected to the lifting frame 10 may advantageously be at a level above an upper level of the container handling vehicle 301. In this manner, the stacker frame 6 may be moved above the storage columns 105 without interfering with the operation of the container handling vehicle 301, and vice versa.

In a third exemplary storage system (not illustrated), both stacker frame lifter 8 and container lifter may be arranged to move above the stacks of stacker frames by a respective crane assembly. The crane assemblies may be configured as shown in FIG. 20 and described above. The third exemplary storage system may optionally be configured without the framework structure of the first and second exemplary storage systems since none of the stacker frame lifter and the container lifter are dependent on a rail system to guide their movement. When the third exemplary storage system is configured without a framework structure, it is advantageous if the bottom section 18 of each stacker frame has a recessed portion 23 having an outer periphery being smaller than an inner periphery of the top section 19, as discussed above in relation to FIG. 12. In this manner, the stacker frames 6 may be stacked on top of another while horizontal movement between them is restricted without support from a framework structure.

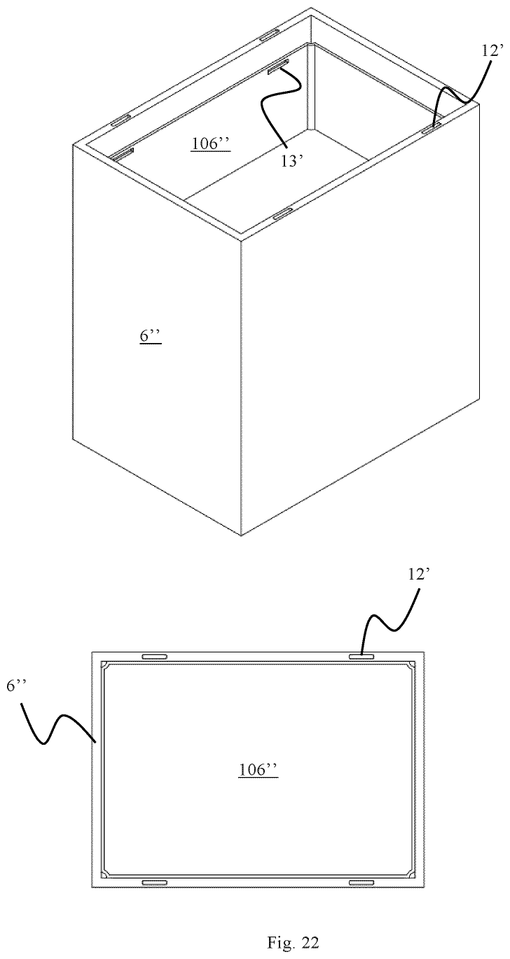

Other versions of combinations of stacker frames and storage containers are shown in FIGS. 21 and 22. The main differentiating feature of these combinations in view of the stacker frame 6 and storage containers 106 discussed above is the positioning of the connecting recesses 13′, 12′ of the storage container 106″ and/or the stacker frame 6″. In both versions, the stacker frame features connecting recesses 12′ in an upper rim thereof. The connecting recesses 12′ may for instance be suitable for connection by a second type of lifting frame (not shown) having grippers similar to the container connectors 3 of the prior art lifting frame 2 in FIG. 4. The connecting recesses 13′ of the storage container 106″, FIG. 22, may for instance be suitable for connection by a first type of lifting frame (not shown) having latches 17 similar to the second type

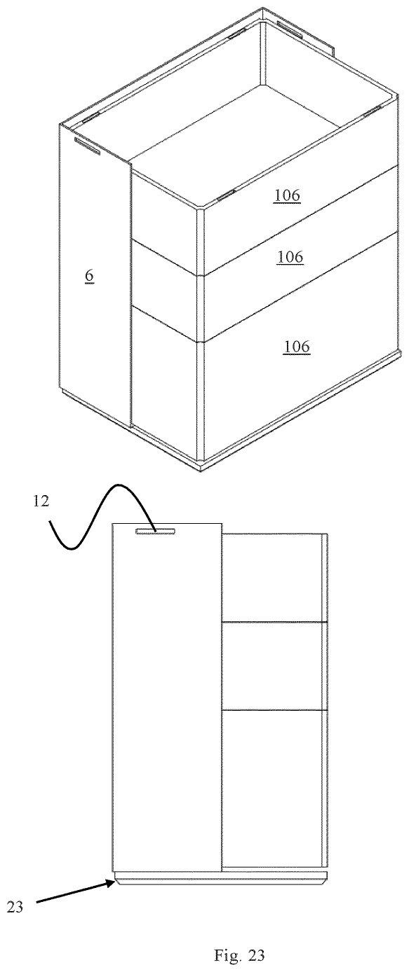

Provided the container handling vehicle 301 (i.e. container lifter) is configured to lift storage containers 106 of different heights, a stack of storage containers in a stacker frame may comprise a mix of such storage containers, see FIG. 23.

### LIST OF REFERENCE NUMBERS

1 Prior art automated storage and retrieval system
2,2′,2″ Lifting frame, first type of lifting frame
3 Container connector
4 Guiding pin
5 Lifting bands
6 Stacker frame
7 Guiding pin recess
8,8′ Stacker frame lifter
9 Open top end
10 Second type of lifting frame
11 Base frame
12 Recess, connecting recess (of a stacker frame)
13 Connecting recess (of a storage container)
14 Sidewall of storage container
15 Lower bottom surface of lifting frame
16 Upper rim of storage container
17 Latch
18 Bottom section (of stacker frame)
19 Top section (of stacker frame)
20 Side section (of stacker frame)
21 Extendable guide elements
22 Upper rim
23 Recessed portion
24 First gantry beam/rail
25 Second gantry beam/rail
26 Telescopic arm
27 Lifting platform
28,28′ First set of wheels
29,29′ Second set of wheels
30 Guide frame, guide plate
31 Aperture
100 Framework structure
102 Upright members of framework structure
103 Horizontal members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art container handling vehicle
201a Vehicle body of the container handling vehicle 201
201b Drive means / wheel arrangement, first direction (X)
201c Drive means / wheel arrangement, second direction (Y)
301 Prior art cantilever container handling vehicle
301a Vehicle body of the container handling vehicle 301
301b Drive means in first direction (X)
301c Drive means in second direction (Y)
401 Prior art container handling vehicle
401a Vehicle body of the container handling vehicle 401
401b Drive means in first direction (X)
401c Drive means in second direction (Y)
Y Second direction
Z Third direction

1. A storage system for storage containers, the storage system comprising a framework structure, stacker frames, storage containers, a stacker frame lifter and a container lifter;
the framework structure defines a plurality of storage columns, and each storage column configured to accommodate a plurality of the stacker frames arranged one on top of another in a vertical stack;
each of the stacker frames has an open top end and is configured to accommodate a plurality of the storage containers stored one on top of another in a vertical stack;
the stacker frame lifter and the container lifter are configured to move above the storage columns;
the container lifter is configured to retrieve a storage container via the open top end of an upper stacker frame of a stack of stacker frames; and
the stacker frame lifter is configured to retrieve an upper stacker frame accommodated in a storage column.

2. A storage system according to claim 1, comprising a rail system on which the container lifter is configured to move the rail system being arranged above the storage columns.

3. A storage system according to claim 2, wherein the stacker frame lifter is configured to move on or above the rail system.

4. A storage system according to claim 1, wherein the container lifter comprises a first type of lifting frame configured to releasably connect to an upper portion of a storage container.

5. A storage system according to claim 4, wherein the first type of lifting frame comprises grippers configured to releasably connect to connector recesses arranged in an upper rim of the storage container.

6. A storage system according to claim 4, wherein the stacker frame lifter comprises a second type of lifting frame configured to releasably connect to an upper portion of a stacker frame.

7. A storage system according to claim 6, wherein each stacker frame has two opposite side sections and each side section comprises a recess arranged at an inner surface, and the second type of lifting frame comprises latches, each latch configured to enter a corresponding recess from inside the stacker frame when the stacker frame is releasably connected to the second type of lifting frame.

8. A storage system according to claim 7, wherein the second type of lifting frame comprises a horizontal base frame and at least one latch arranged at each of two opposite sides of the base frame, a connecting portion of each latch being configured to move between a release position and a connecting position, in the release position the connecting portion is closer to a vertical centreline of the base frame than in the connecting position.

9. A stacker frame and storage container assembly comprising:
a storage system as recited in claim 1;
the assembly comprising a stacker frame accommodating a plurality of storage containers stacked on top of another forming a stack.

10. An assembly according to claim 9, wherein the stacker frame comprises a bottom section, for supporting a lower end of the stack of storage containers, a top section having an open end through which a storage container is configured to pass in a vertical direction, side sections extending between the bottom section and the top section, and connecting recesses arranged at an upper portion of the side sections or at an upper rim of the top section.

11. An assembly according to claim 9, wherein each of the storage containers comprises connecting recesses at an upper rim.

12. An assembly according to claim 10, wherein the bottom section of the stacker frame comprises a recessed portion having an outer periphery being smaller than an inner periphery of the top section, such that two stacker frames are configured to be stacked on top of another and horizontal movement between the two stacker frames are restricted.

13. A method of retrieving a target storage container from a storage system the method comprising:
with a storage system as recited in claim 1:
identifying a storage column accommodating a target stacker frame in which the target storage container is stored;
moving the stacker frame lifter to a position above the storage column;
retrieving at least one stacker frame, stacked above the target stacker frame, from the storage column, until the target stacker frame is the upper stacker frame in the storage column; and
retrieving the target storage container from the target stacker frame by use of the container lifter.

14. The method according to claim 13, further comprising storing the at least one stacker frame in another storage column.

15. The method according to claim 13, further comprising retrieving the target stacker frame from the storage column and moving the target stacker frame to another storage column in which the target stacker frame is stacked at an upper level of the storage column.

16. A lifting device for a container lifter in a storage system comprising a framework structure, stacker frames, storage containers, a stacker frame lifter, and a container lifter, the lifting device comprising:
a first type of lifting frame; and
a guide frame, the guide frame being arranged above the first type of lifting frame and having an outer periphery that is larger than the outer periphery of the first type of lifting frame.

17. The lifting device according to claim 16, wherein the guide frame comprises apertures through which lifting bands from the first type of lifting frame pass.

18. A storage system for storage containers, the storage system comprising stacker frames, storage containers, a stacker frame lifter and a container lifter; wherein:
the stacker frames are arranged one on top of another in a plurality of adjacent vertical stacks;
each of the stacker frames has an open top end and is configured to accommodate a plurality of the storage containers stored one on top of another in a vertical stack;
the stacker frame lifter and the container lifter are configured to move above the stacks of stacker frames;
the container lifter is configured to retrieve a storage container via the open top end of an upper stacker frame of a stack of stacker frames; and
the stacker frame lifter is configured to retrieve an upper stacker frame of a stack of stacker frames.

19. The storage system according to claim 18, wherein one or more of the stacker frame lifter or the container lifter are arranged to move above the stacks of stacker frames by a crane assembly.

20. The storage system according to claim 18, wherein a bottom section of each stacker frame comprises a recessed or stepped portion having an outer periphery being smaller than an inner periphery of a top section of each stacker frame, such that two stacker frames are configured to be stacked on top of another and horizontal movement between the two stacker frames are restricted.
